(19) United States
(12) Patent Application Publication
(10) Pub. No.: US 2013/0299463 A1
(43) Pub. Date: Nov. 14, 2013

(54) HYBRID WELDING METHOD AND WELDING TORCH FOR HYBRID WELDING

(71) Applicants: Shuhei Kanemaru, Kai-shi (JP); Tomoaki Sasaki, Kai-shi (JP); Toyoyuki Sato, Kai-shi (JP)

(72) Inventors: Shuhei Kanemaru, Kai-shi (JP); Tomoaki Sasaki, Kai-shi (JP); Toyoyuki Sato, Kai-shi (JP)

(73) Assignee: TAIYO NIPPON SANSO CORPORATION, Tokyo (JP)

(21) Appl. No.: 13/813,701

(22) PCT Filed: Jul. 28, 2011
(86) PCT No.: PCT/JP2011/067272

§ 371 Date: Apr. 3, 2013

(30) Foreign Application Priority Data
Aug. 5, 2010 (JP) 2010-176580

(51) Int. Cl. B23K 9/16

(52) U.S. Cl. CPC B23K 9/16
USPC 219/74

(57) ABSTRACT

An object of the present invention is to provide a hybrid welding method which can improve the stability of the arc, the welding speed, and welding efficiency, and the present invention provides a hybrid welding method in which a TIG arc is generated on the front side in the welding direction, and a MIG arc is generated on the back side in the welding direction in order to weld a welding base material, wherein electric current for the TIG welding is larger than electric current for the MIG welding; and an absolute value of the interval between an intersection of a center axis of a TIG electrode and a surface of the welding base material and an intersection of a center axis of a MIG electrode and the surface of the welding base material is 4 mm or less.

### TECHNICAL FIELD

The present invention relates to a hybrid welding method and a welding torch for the hybrid welding method.

### BACKGROUND ART

The TIG welding method (Tungsten Inert Gas welding method), in which an arc is generated between a non-consumable tungsten electrode and a material to be welded in an inert gas atmosphere, has been widely used because it is capable of obtaining a welded part with high quality. However, the welding speed of the TIG welding method is lower and welding efficiency is inferior, compared with other welding methods, such as the MAG welding method (Metal Active Gas welding method), MIG welding method (Metal Inert Gas welding method).

In the MAG and MIG welding methods, an arc is generated between a consumable welding wire electrode and a material to be welded respectively in an active gas atmosphere and inert gas atmosphere. As disclosed above, the MAG and MIG welding methods have superior welding efficiency, but sputter is easily generated. In addition, the MAG welding method has a problem in that the toughness of the weld metal is easily deteriorated.

In the MAG and MIG welding methods, the reason for sputter easily occurring is that short-circuit is easily generated between the tip of the welding wire electrode and the welding base material. In addition, the reason for the toughness easily deteriorating in the MAG welding method is that an oxidizing gas in a shielding gas is melted in weld metal, and the oxygen amount of the weld metal is increased.

In order to solve these problems in the MAG and MIG welding methods, various TIG-MIG hybrid welding methods have been suggested (for example, Patent Document No. 1).

When the MIG welding method is carried out to carbon steel or stainless steel using an inert gas such as argon, and helium as a shielding gas, a cathode spot is not fixed and an arc is unstable.

In contrast, metal vapor is generated by the leading TIG arc, and electric current flow is formed there in the TIG-MIG hybrid welding method. Then, a molten pool generated by the TIG arc has a work function which is smaller than that of the solid metal, and easily discharges electrons. Therefore, the cathode spot of the MIG arc is easily fixed to the molten pool.

Thereby, it is possible to stably weld carbon steel or stainless steel using an inert gas as a shielding gas in the TIG-MIG hybrid welding method. Therefore, it is also possible to decrease the amount of oxygen dissolved in the weld metal. In addition, when the wire of the MIG welding electrode is nearly in contact with the welding base material, the tip of the wire is melted and separated as a droplet in the TIG-MIG hybrid welding method. Thereby, short-circuit is not generated between the wire and the welding base material. Due to this, it is also possible to prevent sputtering.

As explained above, the TIG-MIG hybrid welding method can compensate for the shortcomings of the TIG welding method and the MAG welding method (and the MIG welding method). However, the TIG-MIG hybrid welding method has a unique problem caused by stiffness of an arc. Here, “stiffness of an arc” means properties whereby an arc tries to generate straightly in the extend direction of the tungsten electrode or the wire even when the electrode is inclined. In the TIG-MIG hybrid welding method, since the TIG arc and the MIG arc, in which the electric current is completely opposite, are generated at a short interval, the repulsion of arcs is generated by the electromagnetic force.

As a result, in the conventional TIG-MIG hybrid welding method, the arc is easily unstable by the interaction between the stiffness and the repulsion of the arcs which affect to opposite directions each other. When the arc is unstable, an irregularity of weld bead or a blow hole is easily generated.

Meanwhile, in order to decrease the repulsion in the conventional TIG-MIG hybrid welding method, a hot-wire TIG welding method has been used (for example, Patent Document No. 2). A common hot-wire TIG welding is shown in FIG. 13. As shown in FIG. 13, welding is carried out by using resistance heating generated by electrification in the wire without generation of the arc from the wire. Thereby, the MIG arc disappears, and repulsion of the arcs is also lost. Due to this, it is possible to increase the stability of the arc.

Therefore, a power source for heating the wire in the hot-wire TIG welding method can control the voltage lower (for example, 6 to 7 V), dissimilar to the power source in the MIG welding in the TIG-MIG hybrid welding method in which voltage is controlled at a high level (for example, 13 to 30V) in order to generate the arc between the wire and the weld base material.

### PRIOR ART DOCUMENT

### Patent Document

Patent Document No. 1: Japanese Unexamined Patent Application, First Publication No. Sho 53-34653
Patent Document No. 2: Japanese Unexamined Patent Application, First Publication No. Hei 6-79466

### DISCLOSURE OF THE INVENTION

### Problems to be Solved

However, since the voltage of the MIG welding is lower in the conventional hot-wire TIG arc welding method as disclosed in Patent Document No. 2, heating ability to the wire is smaller compared with the conventional TIG-MIG hybrid welding method. Therefore, the conventional hot-wire TIG arc welding method has a problem in that the melting rate of the wire is smaller. In addition, heat input is also smaller, and therefore, the weld penetration is also shallow. As explained above, the welding speed and welding efficiency have been desired to be improved in the conventional hot-wire TIG arc welding method.

In consideration of the above-described problems, it is an object of the present invention to provide a hybrid welding method which can improve the stability of the arc, the welding speed, and welding efficiency, and a welding torch used in the hybrid welding method.

### Means for Solving the Problem

In order to solve the problems, the present invention provides a hybrid welding method and a welding torch in the following (1) to (8).

(1) A hybrid welding method in which a TIG arc is generated on the front side in the welding direction, and a MIG arc is generated on the back side in the welding direction in order to weld a base material, wherein electric current for the TIG welding is larger than electric current for the MIG welding; and an absolute value of the interval between an intersection of a center axis of a TIG electrode and a surface of the welding base material and an intersection of a center axis of a MIG electrode and the surface of the welding base material is 4 mm or less.

(2) The hybrid welding method according to (1), wherein a gas containing 25% or more of helium, and argon gas as residue is used.

(3) The hybrid welding method according to (1), wherein a gas containing 3% to 9% of hydrogen and argon gas as residue is used.

(4) The hybrid welding method according to (1), wherein a gas containing 3% to 9% of hydrogen, 25% or more of helium, and argon gas as residue is used.

(5) The hybrid welding method according to (1), wherein a gas containing 3% to 9% of hydrogen and helium gas as residue is used.

(6) The hybrid welding method according to (1), wherein an absolute total (|a|+|β|) of an angle α of a TIG welding torch that a normal line makes with a center axis of a TIG welding torch when the TIG welding torch is inclined such that a tail point of the TIG welding torch is inclined toward the traveling direction in the welding direction, and an angle β of a MIG welding torch that a normal line makes with a center axis of a MIG welding torch when the MIG welding torch is inclined such that an tail point of the MIG welding torch is inclined toward the opposite direction to the traveling direction in the welding direction is in a range of 30° to 120°.

(7) The hybrid welding method according to (1), wherein a pulsed electric current is flowed to the MIG welding torch, which is positioned trailing to the TIG welding torch in the welding direction.

(8) A torch for the hybrid welding method according to any one of (1) to (7), wherein the torch has one nozzle body, and a TIG electrode and an MIG electrode in the nozzle body, and uses the same shielding gas in generating a TIG arc and a MIG arc.

### Effects of the Present Invention

According to the hybrid welding method according to the present invention, since the TIG electric current is larger than the MIG electric current, the cathode spot region of the trailing MIG arc is never larger than the molten pool made by the leading TIG arc. Therefore, the arc does not readily wobble. Thereby, it is possible to improve the stability of the arc.

In addition, when the thickness of the welding base material to be welded is increased, since the electric current of both TIG and MIG welding can be increased, it is possible to improve the welding speed and welding efficiency.

In addition, according to the hybrid welding method according to the present invention, an absolute value of the interval between an intersection of a center axis of the TIG electrode and a surface of the welding base material and an intersection of a center axis of the MIG electrode and the surface of the welding base material is 4 mm or less. When two arcs are generated closely in this way, the electromagnetic force can be negated. Due to this, the total electromagnetic force can be decreased, and the stiffness of the arc can be relatively increased. Therefore, it is possible to improve the stability of the arc.

Furthermore, according to the present invention, the TIG electric current is larger than the MIG electric current, and at the same time, a gas containing 25% or more of helium, and argon gas as residue is used. When the TIG electric current is larger than the MIG electric current, the cathode spot region of the trailing MIG arc is never larger than the molten pool made by the leading TIG arc. In addition, since the thermal conductivity of helium and hydrogen in the shielding gas is large, arc is cooled from around arc. Thereby, thermal pinch effects are generated, and the generated thermal pinch effects make electric current path concentrate on the center of an arc column. Due to this, the arc itself concentrates more near base material. Therefore, the stiffness of the arc can be increased. Then, the stiffness of the arc is relatively stronger than repulsion of the arcs. Thereby, it is possible to improve the stability of the arc.

According to the torch for the hybrid welding method according to the present invention, the torch has one nozzle body, and a TIG electrode and an MIG electrode in the nozzle body, and uses the same shielding gas in generating a TIG arc and a MIG arc. In this way, since only one kind of the shielding gas can be shared without using different kinds of shielding gas for the TIG arc and the MIG arc, it is possible to reduce the size of the torch.

In addition, since two nozzles are combined to one nozzle, it is possible to decrease the flow amount of the shielding gas.

### BRIEF DESCRIPTION OF DRAWINGS

FIG. 1 is a view illustrating an outline of a gas welding device having a welding torch for a hybrid welding method according to the present invention.

FIG. 2 is an enlarged view illustrating a welding torch for a hybrid welding method according to the present invention.

FIG. 3 is a picture showing the result of a bead appearance test in Examples according to the present invention.

FIG. 4 is a picture showing the result of a bead appearance test in Examples according to the present invention.

FIG. 5 is a picture showing the result of a bead appearance test in Examples according to the present invention.

FIG. 6 is a picture showing the result of a bead appearance test in Examples according to the present invention.

FIG. 7 is a picture showing the result of a bead appearance test in Examples according to the present invention.

FIG. 8 is a picture showing the result of a bead appearance test in Examples according to the present invention.

FIG. 9 is a picture showing the result of a bead appearance test in Examples according to the present invention.

FIG. 10 is a picture showing the result of a bead appearance test in Examples according to the present invention.

FIG. 11 is a picture showing the result of a bead appearance test in Examples according to the present invention.

FIG. 12 is a view showing a wave shape, variation, and frequency of pulsed electric current for MIG welding in Example according to the present invention.

FIG. 13 is a view illustrating the conventional hot-wire TIG arc welding device.

### DESCRIPTION OF EMBODIMENTS

Below, embodiments of the hybrid welding method according to the present invention are explained in detail referring to figures as well as a torch for the hybrid welding method. Moreover, in the figures used in the following embodiments, for convenience, the characteristic part may be enlarged, and the proportion of each element shown in the figures may be different from the actual proportion in order to show clearly the characteristic part.

### First Embodiment

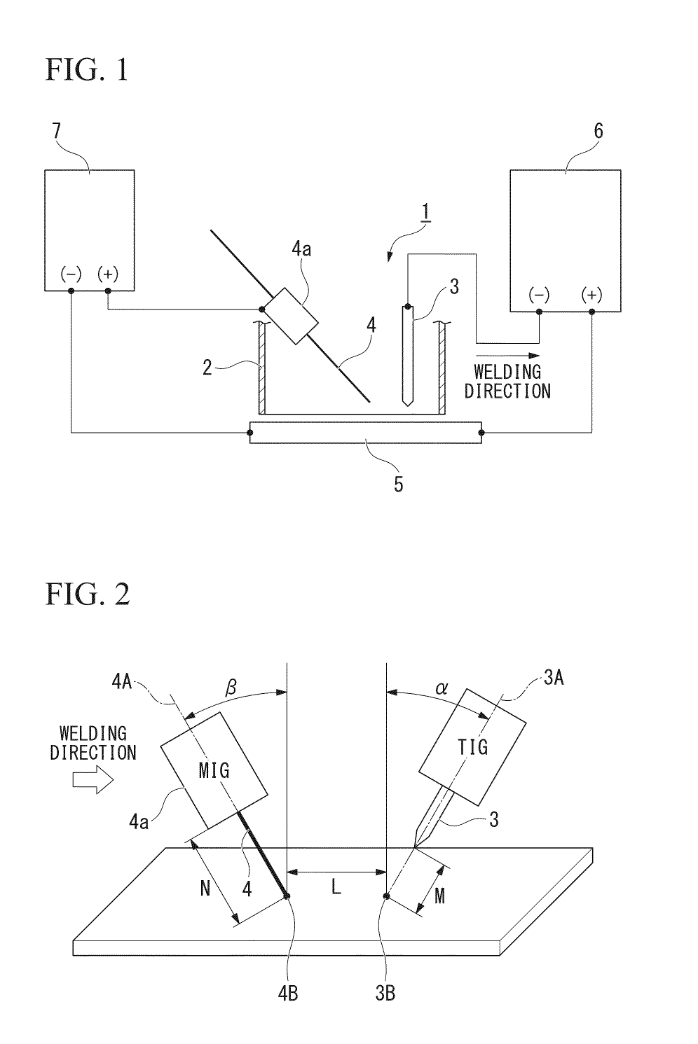

FIG. 1 is a view illustrating an outline of a gas welding device having a welding torch for a hybrid welding method according to the present invention. In FIG. 1, the reference numeral 1 shows a welding torch (a torch for hybrid welding). The welding torch 1 has a cylindrical nozzle body 2, a stick tungsten electrode 3 which is arranged forward in the welding direction in the nozzle body 2, a welding wire 4 which is arranged backward in the welding direction in the nozzle body 2, and a contact tip 4a for flowing electric current to the welding wire 4. The welding torch 1 has a single structure, and uses one kind of a shielding gas (not shown in FIG. 1).

The nozzle body 2 of the welding torch 1 is connected to a shielding gas source for storing the shielding gas (not shown in FIG. 1). The shielding gas from the shielding gas source is supplied to the nozzle body 2, and is blown from the tip of the nozzle body 2 toward the welding base material 5 to be welded.

As the shielding gas in this embodiment, inert gas such as argon (Ar) and helium (He) can be used. However, a gas containing 25% or more of helium, and argon gas as residue is preferably used. When the gas containing 25% or more of helium, and argon gas as residue is used, since the thermal conductivity of helium is large, the arc generated is cooled. Thereby, thermal pinch effects are generated, and the generated thermal pinch effects make electric current paths concentrate on the center of an arc column. At the vicinity of a welding base material 5, the arc itself concentrates more. Thereby, the stiffness of the arc is increased. Then, the stiffness of the arc is relatively stronger than repulsion of the arcs. Thereby, it is possible to improve the stability of the arc.

In addition, it is also possible to obtain the same effects by adding 3% to 9% of hydrogen gas in argon gas, helium gas, or a mixed gas containing argon gas and helium gas. Hydrogen gas is combustible, and there may be a risk of explosion. Therefore, it is necessary to pay attention to handling. When an explosion range in a case of diluting the mixed gas containing hydrogen and nitrogen with air is considered, the upper limit of hydrogen added is set to 9%.

Any materials can be used as the welding base material 5 without any limitations. Specifically, nickel alloys, aluminum-based materials, magnesium-based materials, copper-based materials, iron- and steel-based materials such as stainless steels and carbon steels, and the like can be used. Among these, iron- and steel-based materials, which have had problems in the TIG welding, or MAG welding, are preferably used.

The tungsten electrode 3 in the welding torch 1 is connected to a minus terminal of a welding electric power source 6. Welding electric current is applied between the tungsten electrode 3 and the welding base material 5 connected to a plus terminal of the welding electric power source 6. Thereby, a TIG arc is generated on the surface of the welding base material 5.

Here, as shown in FIG. 2, it is possible to incline the tungsten electrode (TIG electrode) 3 so as to make an angle α of a TIG welding torch that a normal line makes with a center axis 3A of the TIC welding torch when the TIC welding torch is inclined such that a tail point of the TIG welding torch is inclined toward the traveling direction in the welding direction.

In addition, the length M of the TIG arc is not particularly limited, and can be selected depending on the kinds or thickness of the welding base material 5. Specifically, the length M of the TIG arc is preferably in a range of 2 to 20 mm.

The welding wire 4 is not particularly limited, and may be a solid wire, or a metal-based flux-containing wire. The welding wire 4 can be selected depending on the material or the quality of the welding base material 5 to be welded.

The welding wire 4 is inserted in a passage formed in a contact tip 4a, and can be supplied from the end of the welding torch 1 toward the outside. The contact tip 4a is connected to the plus terminal of the welding electric power source 7. Welding electric current is applied between the welding wire 4 and the welding base material 5 connected to a minus terminal of the welding electric power source 7. Thereby, a MIG arc is generated on the surface of the welding base material 5.

Here, as shown in FIG. 2, it is possible to incline the welding wire (MIG electrode) 4 so as to make an angle β of a MIG welding torch that a normal line makes with a center axis 4A of the MIG welding torch when the MIG welding torch is inclined such that a tail point of the MIG welding torch is inclined toward the opposite direction to the traveling direction in the welding direction.

Moreover, the absolute total (|α|+|β|) of the angle α of the TIG welding torch that a normal line makes with the center axis 3A of the TIG welding torch and an angle β of the MIG welding torch that the normal line makes with the center axis 4A of the MIG welding torch is preferably in a range of 30° to 120°. When the arcs are generated closely in this way, the arcs are overlapped. The electromagnetic force is negated in the overlapped portion. Due to this, the total electromagnetic force is decreased, and the stiffness of the arc is relatively increased. Therefore, it is possible to improve the stability of the arc. In order to prevent the contact between the welding torch and the welding base material to be welded, the upper limit of the absolute total angle is set to 120°.

The length N of the welding wire 4 extended from the contact tip 4a is not particularly limited, and can be selected depending on the kinds and thickness of the welding base material 5. However, the length N is preferably in a range of 10 to 30 mm.

In the welding torch 1 in this embodiment, an absolute interval value L between the arcs, that is, an absolute interval value L of the intersection 3B between the center axis 3A of the tungsten electrode (TIG electrode) and the surface of the welding base material 5 and the intersection 4B between the center axis 4A of the welding wire (MIG electrode) and the surface of the welding base material 5, is set to 4 mm or less.

The interval between the arcs is denoted by the absolute value L in the present invention in order to include not only the conditions as shown in FIG. 2 in which the intersection 3B of the leading TIG electrode is positioned more forward than the intersection 4B of the trailing MIG electrode in the traveling direction of the welding direction but also the conditions in which the intersection 4B of the trailing MIG electrode is positioned more forward than the intersection 3B of the TIG electrode in the traveling direction of the welding direction.

Next, the hybrid welding method using the welding device is explained.

First, the shielding gas is supplied from the shielding gas source to the welding torch 1. Then, the welding electric power source 6 is operated to apply the welding electric current (TIG electric current) between the tungsten electrode 3 and the welding base material 5 and the TIG arc is generated. In addition, the MIG arc is generated by operating the welding electric power source 7, and flowing the welding electric current (MIG electric current) between the welding wire 4 and the welding base material 5. Thereby, welding is carried out.

In the hybrid welding method using the leading TIG-trailing MIG hybrid welding device as explained above, the surface of the welding base material 5 is heated and melted by the leading TIG arc, and a molten pool is formed. The cathode spot of the trailing MIG arc is formed on the molten pool.

In order to improve the welding speed and welding efficiency, it is necessary to increase the electric current of both the TIG and MIG depending on the increase of the thickness of the welding base material 5 to be welded. In this embodiment, first, the TIG electric current is increased. Along with the increase of the TIG electric current, the amount of metal vapor between the welding torch 1 and the welding base material 5 is increased, and at the same time, the molten pool formed on the welding base material 5 becomes larger.

Then, the MIG electric current is increased. However, the MIG electric current is adjusted so as not to exceed the TIG electric current in this embodiment. That is, the TIG electric current is set to be larger than the MIG electric current.

When the electric current (MIG electric current) to the trailing MIG arc is larger than the electric current (TIG electric current) to the leading TIG arc, the shape of the bead, specifically, the toe of the bead, is unstable. More specifically, along with an increase of the trailing MIG electric current, the MIG arc is larger, and thereby the welding rate is increased. However, when the leading TIG electric current is smaller than the trailing MIG electric current, the area of the molten pool formed on the welding base material 5 by the TIG arc becomes smaller. Due to this, the MIG arc extends over the width of the molten pool. Then, the MIG arc other than the molten pool is unstable. Thereby, winding of the bead is easily caused. In addition, the area of the molten pool made by the TIG arc is smaller, the extension width of the trailing MIG arc is limited, and wettability of the bead is deteriorated.

In contrast, according to the hybrid welding method in this embodiment, since the TIG electric current is adjusted to be larger than the MIG electric current, the cathode spot region of the trailing MIG arc is never larger than the area of the molten pool made by the leading TIG arc. Thereby, winding of the bead is not readily caused, and stability of the arc can be improved. In addition, when the thickness of the welding base material 5 to be welded is larger, since both of the TIG electric current and the MIG electric current can be increased, it is possible to increase the welding speed and the welding efficiency.

In addition, as shown in FIG. 2, the absolute value of the interval between the intersection 3B between the center axis 3A of the tungsten electrode (TIG electrode) 3 and the surface of the welding base material 5 and an intersection 4B between the center axis 4A of the welding wire (MIG electrode) 4 and the surface of the welding base material 5 is 4 mm or less in the hybrid welding method in this embodiment. That is, the absolute value of the interval between the arcs is 4 mm or less.

When the absolute value of the interval between the arcs exceeds 4 mm, the TIG arc and the MIG arc do not overlap, large electromagnetic force is generated, and the arc is unstable. In addition, when the MIG arc passes, the amount of the metal vapor made between the welding torch 1 and the welding base material 5 is insufficient, and the molten pool formed on the surface of the welding base material 5 is small. Due to this, winding of the arc is easily generated. As a result, the shape of the bead (the toe of the bead) is unstable.

In contrast, according to the hybrid welding method in this embodiment, the absolute interval value L between the arcs is set to 4 mm or less. The TIG arc and the MIG arc are generated closely, and overlapped. In this overlapped portion, the electromagnetic force is negated. The total electromagnetic force is decreased, and the stiffness of the arc is larger than the repulsion of the arcs. Therefore, it is possible to improve the stability of the arc.

In addition, when two arcs are generated closely, and the MIG arc passes, the amount of the metal vapor made between the welding torch 1 and the welding base material 5 is sufficient, and the molten pool formed on the surface of the welding base material 5 is sufficiently large. Due to this, the stability of the arc is improved.

### Second Embodiment

The second embodiment according to the present invention is explained below. In this second embodiment, the welding device which is used in the first embodiment can be used. However, the hybrid welding method in this second embodiment is different from the hybrid welding method in the first embodiment. Therefore, since the structure of the welding device used in this embodiment is the same as that of the welding device used in the first embodiment, the explanation about the welding device is omitted in this second embodiment.

In the hybrid welding method in this embodiment, the TIG electric current is set to be larger than the MIG electric current, and a gas containing 25% or more of helium, and argon gas as residue is used.

According to the hybrid welding method in this embodiment, since the TIG electric current is set to be larger than the MIG electric current, the cathode spot region of the trailing MIG arc is never larger than the molten pool formed by the leading TIG arc. In addition, since the thermal conductivity of helium contained in the shielding gas is large, the arc generated is cooled. Thereby, thermal pinch effects are generated, and the generated thermal pinch effects make electric current paths concentrate on the center of an arc column. Due to this, the arc itself is shrunk near the welding base material. Therefore, the stiffness of the arc is increased. Then, the stiffness of the arc is relatively stronger than repulsion of the arcs. Thereby, it is possible to improve the stability of the arc.

Moreover, the present invention is not limited to these embodiments. Any variations can be added in the present invention as long as the variation does not depart from the scope of the present invention.

For example, the torch 1 in the welding device in the first embodiment has the nozzle body 2 having a single structure. However, it is possible to use a multiple structure, and the shielding gas explained above can be supplied in an inner nozzle, and an inert gas can be supplied to an outer nozzle.

In addition, the tungsten electrode (TIG electrode) 3 and the welding wire (MIG electrode) 4 are arranged in the nozzle body 2 in the welding torch 1 in the first embodiment. However, the present invention is not limited to this embodiment. For example, a welding torch (MIG welding torch) having a nozzle body in which the tungsten electrode is arranged and a welding torch (MIG welding torch) having a nozzle body in which the welding wire is arranged can be positioned respectively forward and backward in the welding direction, and the leading TIG arc and the trailing MIG arc can be obtained.

Moreover, when the leading TIG and the trailing MIG are carried out by the different welding torches as explained above, the angle of the TIG welding torch that a normal line makes with the center axis of the TIG welding torch when the TIG welding torch is inclined such that a tail point of the TIG welding torch is inclined toward the traveling direction in the welding direction is denoted by the torch angle α (refer to FIG. 2). In addition, an angle of the MIG welding torch that a normal line makes with the center axis of the MIG welding torch when the MIG welding torch is inclined such that a tail point of the MIG welding torch is inclined toward the opposite direction of the traveling direction in the welding direction is denoted by the torch angle β (refer to FIG. 2).

Below, examples according to the present invention are explained.

### (Verification Test 1)

The leading TIG welding torch and the trailing MIG welding torch, which were different to each other, were used. Using a welding device, in which the torch angle of the leading TIG welding torch was set to a, and the torch angle of the trailing MIG welding torch was set to β, common carbon steel (SM490A) was used as the welding base material, and welded. Moreover, the welding conditions are shown in Table 1. In addition, the test results of the bead appearance depending on the arc interval L are shown in Table 2.

TABLE 1

| | | |
|---|---|---|
| Leading TIG electric current | 300 | A |
| Trailing MIG electric current | 250 | A |
| Welding speed | 20 | cm/mm |
| Arc interval L | −2~16 | mm |
| Leading shielding gas/Flow | Ar/12 | L/min |
| rate | | |
| Trailing shielding gas/Flow | Ar/15 | L/min |
| rate | | |
| TIG arc length M | 5 | mm |

| | |
|---|---|
| Torch angle α | 30° (angle relative to the normal |
| | line in traveling direction in the |
| | welding direction is denoted by plus) |
| Torch angle β | −30° (angle relative to the normal |
| | line in traveling direction in the |
| | welding direction is denoted by plus) |

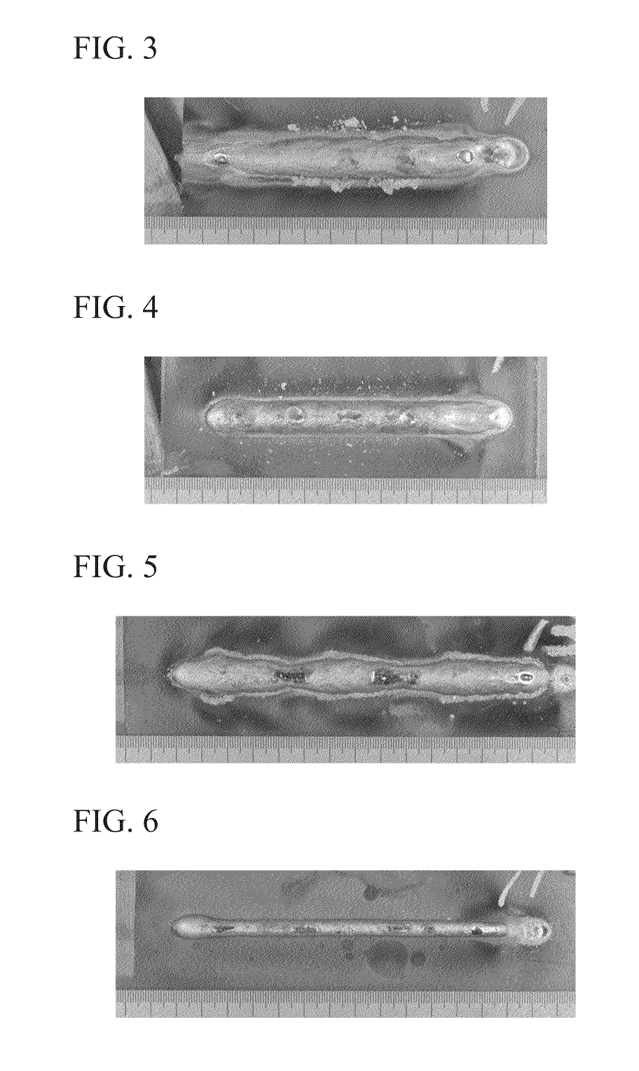

TABLE 2

| Interval (mm) | Results | Pass or Fail |
|---|---|---|
| 16 | Bead irregular | Fail |
| 12 | Bead irregular | Fail (see FIG. 3) |
| 8 | Bead irregular | Fail |
| 4 | Good | Pass |
| 0 | Good | Pass (see FIG. 4) |
| −2 | Good | Pass |

As shown in Table 2, it was confirmed that in order to weld stably, the absolute interval L between the arcs should be 4 mm or less.

### (Verification Test 2)

The leading TIG welding torch and the trailing MIG welding torch, which were different to each other, were used. Using a welding device, in which the torch angle of the leading TIG welding torch was set to a, and the torch angle of the trailing MIG welding torch was set to β, common carbon steel (SM490A) was used as the welding base material, and welded. Moreover, the welding conditions are shown in Table 3. In addition, the test results of the bead appearance based on the relationship between the leading TIG electric current and the trailing MIG electric current are shown in Table 4.

TABLE 3

| | Condition 1 | | Condition 2 | |
|---|---|---|---|---|
| Leading TIG electric | 200 | A | 300 | A |
| current | | | | |
| Trailing MIG electric | 100~225 | A | 150~350 | A |
| current | | | | |
| Welding speed | 20 | cm/min | 30 | cm/min |
| Arc interval L | 4 | mm | 4 | mm |
| Leading shielding gas/Flow | Ar/12 | L/min | Ar/12 | L/min |
| rate | | | | |
| Trailing shielding gas/Flow | Ar/15 | L/min | Ar/15 | L/min |
| rate | | | | |
| TIG arc length M | 5 | mm | 5 | mm |

| | |
|---|---|
| Torch angle α | 30° (angle relative to the normal line in |
| | traveling direction in the welding direction is |
| | denoted by plus) |
| Torch angle β | −30° (angle relative to the normal line in |
| | traveling direction in the welding direction is |
| | denoted by plus) |

TABLE 4

| Leading TIG | Trailing MIG | | |
|---|---|---|---|
| electric current | electric current | | |
| (A) | (A) | Results | Pass or Fail |
| 200 | 225 | Bead irregular | Fail (see FIG. 5) |
| | 200 | Good | Pass |
| | 175 | Good | Pass (see FIG. 6) |
| | 150 | Good | Pass |
| 300 | 300 | Good | Pass |
| | 250 | Good | Pass |
| | 200 | Good | Pass |

As shown in Table 4, it was confirmed that a molten pool, which is required to obtain a stable trailing MIG arc, could be obtained by adjusting the leading TIG electric current equal or more of the trailing MIG electric current.

### (Verification Test 3)

The leading TIG welding torch and the trailing MIG welding torch, which were different to each other, were used. Using a welding device, in which the torch angle of the leading TIG welding torch was set to a, and the torch angle of the trailing MIG welding torch was set to β, common carbon steel (SM490A) was used as the welding base material, and welded. Moreover, the welding conditions are shown in Table 5. In addition, in order to confirm the stabilizing effects obtained by He and H₂ in the shielding gas, the welding speed was set to 40 cm/min, which yielded irregular bead when using pure Ar gas as the shielding gas. The test results of the bead appearance by changing the concentration of helium and hydrogen in the shielding gas are shown in Table 6. Moreover, the same leading and trailing shielding gas was used in the tests.

TABLE 5

| Leading TIG electric current | 300 | a |
|---|---|---|
| Trailing MIG electric current | 240 | a |
| Welding speed | 40 | cm/min |
| Arc interval L | 4 | mm |
| Leading shielding gas/Flow | Ar based He: 0~90%/15-33 L/min | |
| rate | Ar based H₂: 1~9%/15 L/min | |
| Trailing shielding gas/Flow | Ar based He: 0~90%/25-55 L/min | |
| rate | Ar based H₂: 1~9%-25 L/min | |
| TIG arc length M | 5 | mm |

| | |
|---|---|
| Torch angle α | 30° (angle relative to the normal |
| | line in traveling direction in the |
| | welding direction is denoted by plus) |
| Torch angle β | −30° (angle relative to the normal |
| | line in traveling direction in the |
| | welding direction is denoted by plus) |

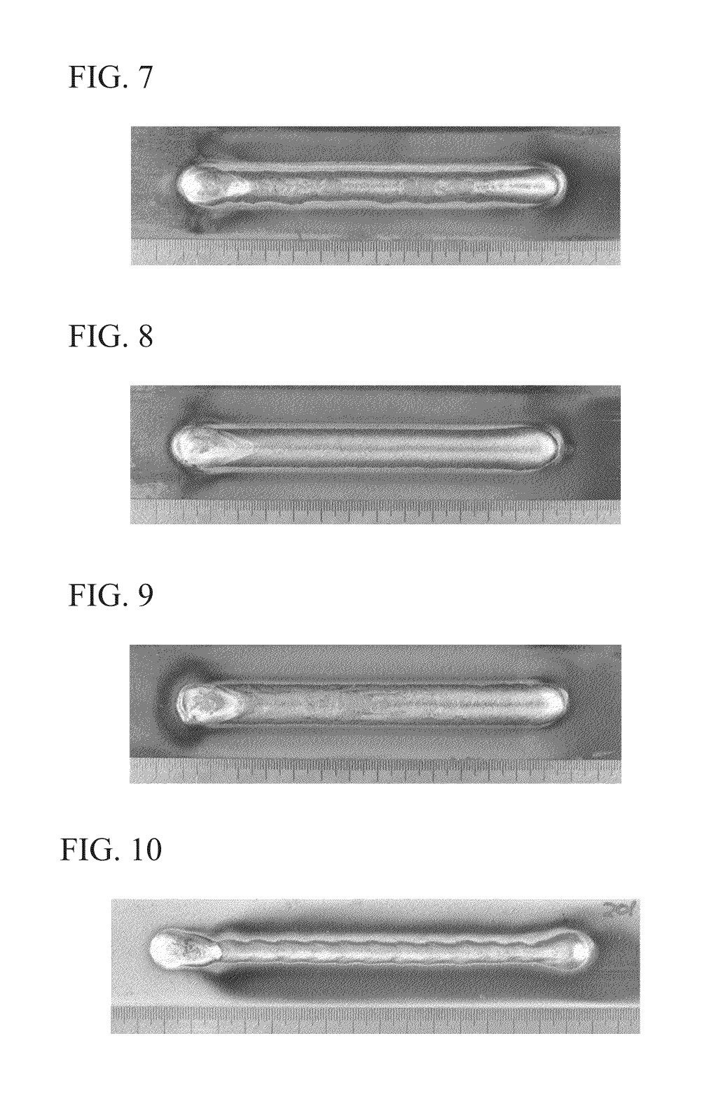

TABLE 6

| He | Hydrogen | | |
|---|---|---|---|
| concentration (%) | concentration (%) | Results | Pass or fail |
| 0 | 0 | Bead irregular | Fail |
| 10 | 0 | Bead irregular | Fail (see FIG. 7) |
| 25 | 0 | Good | Pass |
| 50 | 0 | Good | Pass (see FIG. 8) |
| 75 | 0 | Good | Pass |
| 90 | 0 | Good | Pass |
| 0 | 1 | Bead irregular | x |
| 0 | 3 | Good | Pass |
| 0 | 5 | Good | Pass |
| 0 | 7 | Good | Pass (see FIG. 9) |
| 0 | 9 | Good | Pass |
| 25 | 3 | Good | Pass |
| 25 | 9 | Good | Pass |
| 90 | 3 | Good | Pass |
| 90 | 9 | Good | Pass |
| 97 | 3 | Good | Pass |
| 95 | 5 | Good | Pass |
| 97 | 7 | Good | Pass |
| 99 | 9 | Good | Pass |

As shown in Table 6, it was confirmed that the arc stability could be improved by adding helium or hydrogen in the shielding gas. In addition, since helium and hydrogen has high arc voltage, when 100%-helium gas or a mixed gas containing helium and hydrogen is used as the shielding gas, the arc generation may be unstable on start up of the TIG arc or during welding. Therefore, it is preferable that 10% or more of argon gas be contained in the shielding gas.

### (Verification Test 4)

The leading TIG welding torch and the trailing MIG welding torch, which were different to each other, were used. Using a welding device, in which the torch angle of the leading TIG welding torch was set to a, and the torch angle of the trailing MIG welding torch was set to β, common carbon steel (SM490A) was used as the welding base material, and welded. Moreover, the welding conditions are shown in Table 7. In addition, the test results of the arc by a high speed camera depending on the torch angles α and β are shown in Table 8.

TABLE 7

| | | |
|---|---|---|
| Leading TIG electric current | 350 | A |
| Trailing MIG electric current | 250 | A |
| Welding speed | 30 | cm/min |
| Arc interval L | 4 | mm |
| Leading shielding gas/Flow | Ar 100%/25 | L/min |
| rate | | |
| Trailing shielding gas/Flow | Ar 100%/25 | L/min |
| rate | | |
| TIG arc length M | 5 | mm |

| | |
|---|---|
| Torch angle α | 0~60° (angle relative to the normal |
| | line in traveling direction in the |
| | welding direction is denoted by plus) |
| Torch angle β | 0~−60° (angle relative to the normal |
| | line in traveling direction in the |
| | welding direction is denoted by plus) |

TABLE 8

| Torch angle | Torch angle | | | |
|---|---|---|---|---|
| α | β | \|α\| + \|β\| | | |
| (°) | (°) | (°) | Results | Pass or Fail |
| 10 | −10 | 20 | Arc unstable | Fail |
| 15 | −15 | 30 | Arc stable | Pass |
| 30 | −30 | 60 | Arc stable | Pass |
| 45 | −45 | 90 | Arc stable | Pass |
| 60 | −60 | 120 | Arc stable | Pass |
| 0 | −20 | 20 | Arc unstable | Fail |
| 0 | −30 | 30 | Arc stable | Pass |
| 0 | −45 | 45 | Arc stable | Pass |

As shown in Table 8, it was confirmed that when the total angle (|a|+|β|) of α and β is in a range of 30 to 120°, the arc is further stable, and excellent welding results were obtained.

### (Verification Test 5)

The leading TIG welding torch and the trailing MIG welding torch, which were different to each other, were used. Using a welding device, in which the torch angle of the leading TIG welding torch was set to a, and the torch angle of the trailing MIG welding torch was set to β, common carbon steel (SM490A) was used as the welding base material, and welded. Moreover, the welding conditions are shown in Table 9. In addition, in order to confirm the stabilizing effects obtained by flowing the pulsed electric current for the MIG welding, the welding speed was set to 40 cm/min, which yielded irregular bead when using pure Ar gas as the shielding gas. Furthermore, the test results of the bead appearance depending on presence or absence of pulse are shown in Table 10. Moreover, the wave shape, current variation, and frequency of the MIG pulsed electric current are shown in FIG. 12.

TABLE 9

| Leading TIG electric current | 300 | A |
|---|---|---|
| Trailing MIG electric current | 180 | A |
| Trailing MIG pulse | Presence or Absence | |
| Welding speed | 40 | m/min |
| Arc interval L | 4 | mm |
| Leading shielding gas/Flow | Ar 100%/25 | L/min |
| rate | | |
| Trailing shielding gas/Flow | Ar 100%/25 | L/min |
| rate | | |
| TIG arc length M | 5 | mm |
| Torch angle α | 0° (angle relative to the normal | |
| | line in traveling direction in the | |
| | welding direction is denoted by plus) | |
| Torch angle β | −45° (angle relative to the normal | |
| | line in traveling direction in the | |
| | welding direction is denoted by plus) | |
| Pulse addition: | 280~500 | A |
| peak electric current | | |
| Pulse addition: | 60~80 | A |
| Base electric current | | |
| Pulse addition: frequency | 80~140 | Hz |

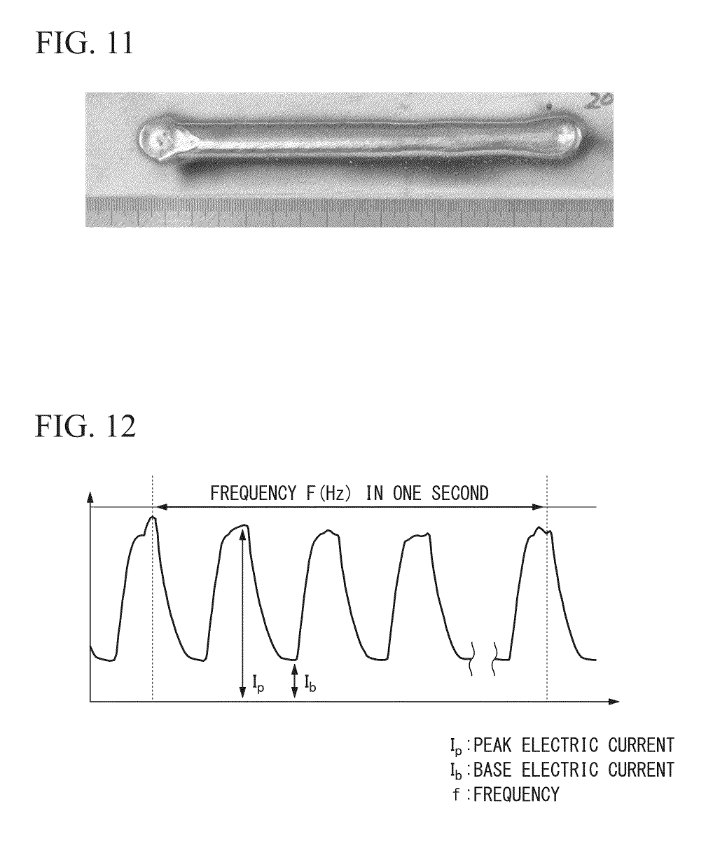

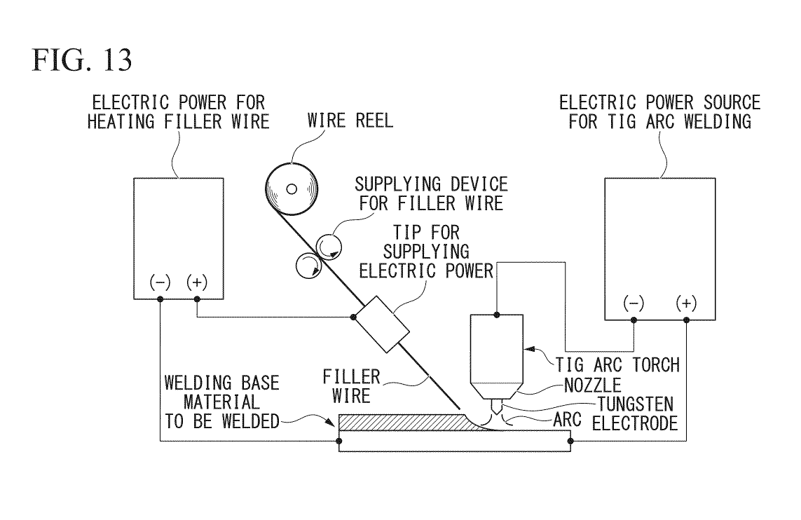

TABLE 10

| Trailing MTG | Welding | | | |
|---|---|---|---|---|
| Electric | speed | | | |
| current (A) | (cm/min) | MIG Pulse | Results | Pass and Fail |
| 180 | 40 | Presence | Bead | Fail (see FIG. 10) |
| | | | irregular | |
| 180 | 40 | Absence | Good | Pass (see FIG. 11) |

As shown in Table 10, it was confirmed that when the trailing MIG electric current was pulsed, the increase of stiffness of the trailing MIG arc was increased, the trailing MIG arc was stable, and excellent bead appearance was obtained.

In addition, it is preferable that the hybrid welding method according to the present invention be used to weld the welding base material in a flat position. However, the position of the welding base material is not limited to flat position, the welding base material can be in all positions.

### INDUSTRIAL APPLICABILITY

The hybrid welding method according to the present invention can be used in nuclear containers, various pressure containers, and products which have used only the TIG welding method from the viewpoint of toughness and sputter

In addition, recently, various wire makers and welding device makers have developed a clean MIG welding method as a method for decreasing the oxygen amount in the iron-based welding metal. The hybrid welding method according to the present invention is one of the solutions for developments.

### REFERENCE SIGNS LIST

1: welding torch (welding torch for hybrid welding)
2: nozzle body
3: tungsten electrode (TIG electrode)
4: welding wire (MIG electrode)
5: welding base material
6 and 7: welding electric power source
L: arc interval

1. A hybrid welding method in which a TIG arc is generated on the front side in the welding direction, and a MIG arc is generated on the back side in the welding direction in order to weld a welding base material, wherein electric current for the TIG welding is larger than electric current for the MIG welding; and an absolute value of the interval between an intersection of a center axis of a TIG electrode and a surface of the welding base material and an intersection of a center axis of a MIG electrode and the surface of the welding base material is 4 mm or less.

2. The hybrid welding method according to claim 1, wherein a gas containing 25% or more of helium, and argon gas as residue is used.

3. The hybrid welding method according to claim 1, wherein a gas containing 3% to 9% of hydrogen and argon gas as residue is used.

4. The hybrid welding method according to claim 1, wherein a gas containing 3% to 9% of hydrogen, 25% or more of helium, and argon gas as residue is used.

5. The hybrid welding method according to claim 1, wherein a gas containing 3% to 9% of hydrogen and helium gas as residue is used.

6. The hybrid welding method according to claim 1, wherein an absolute total
(|a|+|β|) of an angle α of a TIG welding torch that a normal line makes with a center axis of a TIG welding torch when the TIG welding torch is inclined such that a tail point of the TIG welding torch is inclined toward the traveling direction in the welding direction, and an angle β of a MIG welding torch that a normal line makes with a center axis of a MIG welding torch when the MIG welding torch is inclined such that an tail point of the MIG welding torch is inclined toward the opposite direction to the traveling direction in the welding direction is in a range of 30° to 120°.

7. The hybrid welding method according to claim 1, wherein a pulsed electric current is flowed to the MIG welding torch, which is positioned trailing to the TIG welding torch in the welding direction.

8. A torch for the hybrid welding method according to claim 1, wherein the torch has one nozzle body, and a TIG electrode and an MIG electrode in the nozzle body, and uses the same shielding gas in generating a TIG arc and a MIG arc.
